(19) United States
(12) Patent Application Publication
(10) Pub. No.: US 2015/0108010 A1
(43) Pub. Date: Apr. 23, 2015

(54) METHOD AND DEVICE FOR MEASURING COAGULATION IN A SAMPLE OF A BLOOD PRODUCT

(71) Applicant: Vivacta Limited, Sittingbourne, Kent (GB)

(72) Inventors: Steven Andrew Ross, Sittingbourne (GB); Paul Brendan Monaghan, Sittingbourne (GB); Timothy Joseph Carter, Sittingbourne (GB)

(73) Assignee: Vivacta Limited, Sittingbourne, Kent (GB)

(21) Appl. No.: 14/364,832

(22) PCT Filed: Dec. 11, 2012
(86) PCT No.: PCT/GB2012/053088

§ 371 Date: Jun. 12, 2014

Related U.S. Application Data
(60) Provisional application No. 61/569,925, filed on Dec. 13, 2011.

(30) Foreign Application Priority Data
Dec. 12, 2011 (GB) 1121269.3

(51) Int. Cl. G01N 27/327

(52) U.S. Cl. CPC G01N 27/327
USPC 205/792; 204/403.01

(57) ABSTRACT

This invention relates to a method for measuring coagulation in a sample of a blood product comprising: providing a transducer (3) having a pyroelectric or piezoelectric element and electrodes (4, 5) which is capable of transducing energy generated by non-radiative decay into an electrical signal; contacting the transducer with the sample; irradiating the sample with a series of pulses of electromagnetic radiation from a light source (6); and detecting with a detector (7) the electrical signal generated by the transducer 3; wherein the sample contains particles (2), such as red blood cells (2), which are capable of absorbing the electromagnetic radiation generated by the radiation source (6) to generate energy by non-radiative decay, such as heat or shock waves, and wherein the wavelength of the electromagnetic radiation is such that the absorption of the radiation by particles (2) generates energy by non-radiative decay. A device (1) is also provided.

The present invention relates to a method for blood measurement, and particularly to measuring coagulation status.

Coagulation is a process by which blood clots and it plays a critical role in the cessation of blood loss from a damaged blood vessel (hemostasis). The measurement of coagulation is therefore clinically important. Coagulation occurs via a complex mechanism and has two pathways leading to fibrin formation. These two pathways are the contact activation pathway (also known as the intrinsic pathway) and the tissue factor pathway (also known as the extrinsic pathway). A number of different methodologies are currently available for determining clotting rates. These methodologies include the activated partial thromboplastin time (aPTT) which is a measure of the intrinsic clotting pathway, the prothrombin time (PT) which is a measure of the extrinsic clotting pathway, the activated clotting time (ACT) which is for patients on high-dose heparin therapy, the INR (the ratio of PT for a patient sample against a normal sample) and the thrombin generation time. Although each of these approaches functions under different conditions, the actual physical measurement is the same in each one, namely the time for the blood sample physically to clot.

There are a number of methods that are used to measure the rate of clotting, the majority of which focus on measuring a physical parameter relating to the sample. These include:
Visual inspection: a sample of blood is placed in a glass container and observed. The appearance of a clot can be seen by visual inspection.
Light scattering: plasma is separated from the red cells and treated with thromboplastin. Fibrin strand formation makes the sample turbid, which can be measured by light scattering.
Electromechanical methods: one example is the mechanical plunger method in which a plunger is moved in and out of an activated blood sample. Clot formation changes the viscosity of the sample, which is then detected. Another example is the use of a microcantilever.
The thromboelastograph: a pin is suspended from a wire into the blood sample in a cuvette. The cuvette is rotated backwards and forwards. The movement of the pin gives a number of useful parameters relating to clot formation.
Magnetic methods: the sample is placed in a small tube containing a magnet and the tube is rotated in a horizontal orientation. If the sample has not clotted, then the magnet will spin freely and lie on the bottom of the tube. Once the sample starts to clot, the magnet is immobilised in the clot and moves round the tube, which can be detected.
Electrochemical methods: the Roche CoaguChek® is a point-of-care device that works on an electrochemical method. Thrombin (factor IIa) cleaves a peptide substrate, generating an electrochemical signal.
Viscosity measurements: blood is pumped back and forth through a capillary and the velocity of movement is monitored optically.

However, there remains a need in the art for a simple, accurate and versatile approach for measuring coagulation.

Accordingly, the present invention provides method for measuring coagulation in a sample of a blood product comprising:
providing a transducer having a pyroelectric or piezoelectric element and electrodes which is capable of transducing energy generated by non-radiative decay into an electrical signal;
contacting the transducer with the sample;
irradiating the sample with a series of pulses of electromagnetic radiation;
and detecting the electrical signal generated by the transducer;
wherein the sample contains particles which are capable of absorbing the electromagnetic radiation generated by the radiation source to generate energy by non-radiative decay and wherein the wavelength of the electromagnetic radiation is such that the absorption of the radiation by particles generates energy by non-radiative decay.

Thus, the present invention provides a method by which the movement of particles within the sample towards or away from the transducer is perturbed by a coagulation event and that perturbation in the movement of the particles over time provides a measure of coagulation rate.

The present invention will now be described with reference to the drawings, in which:

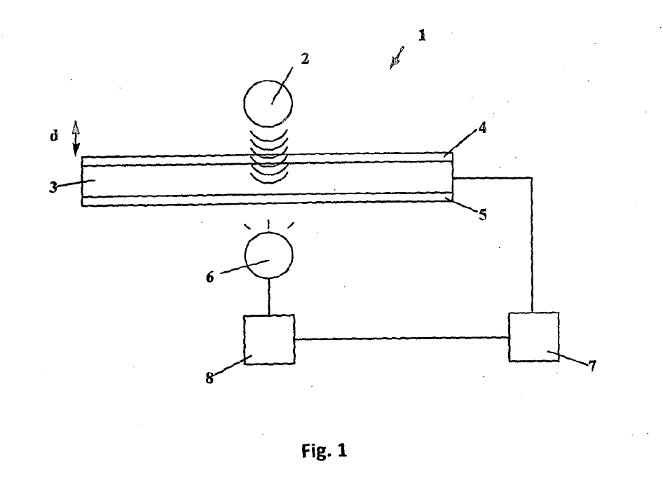

FIG. 1 shows a schematic representation of the chemical sensing device of WO 2004/090512 which is used with the present invention;

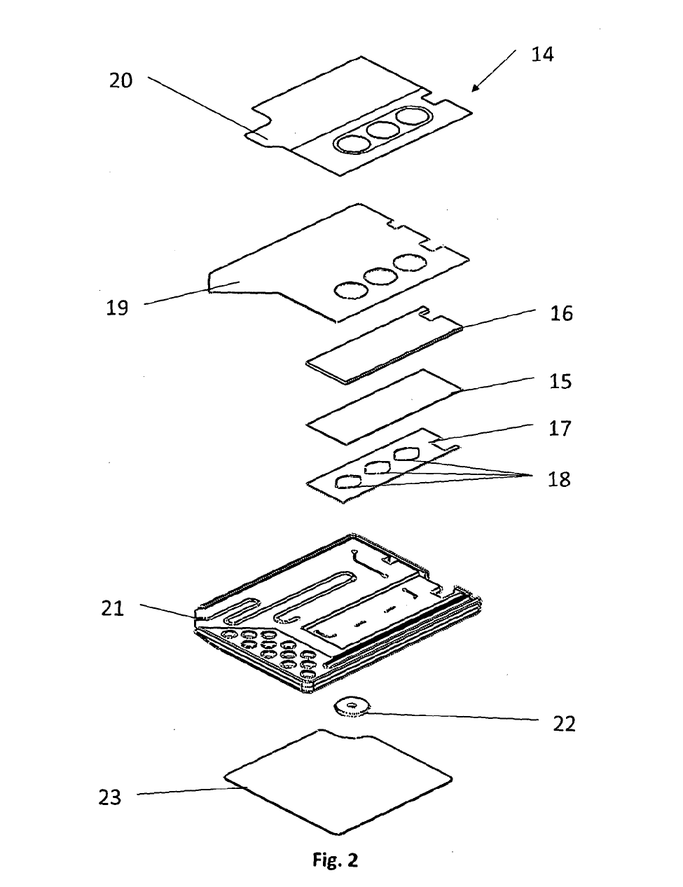

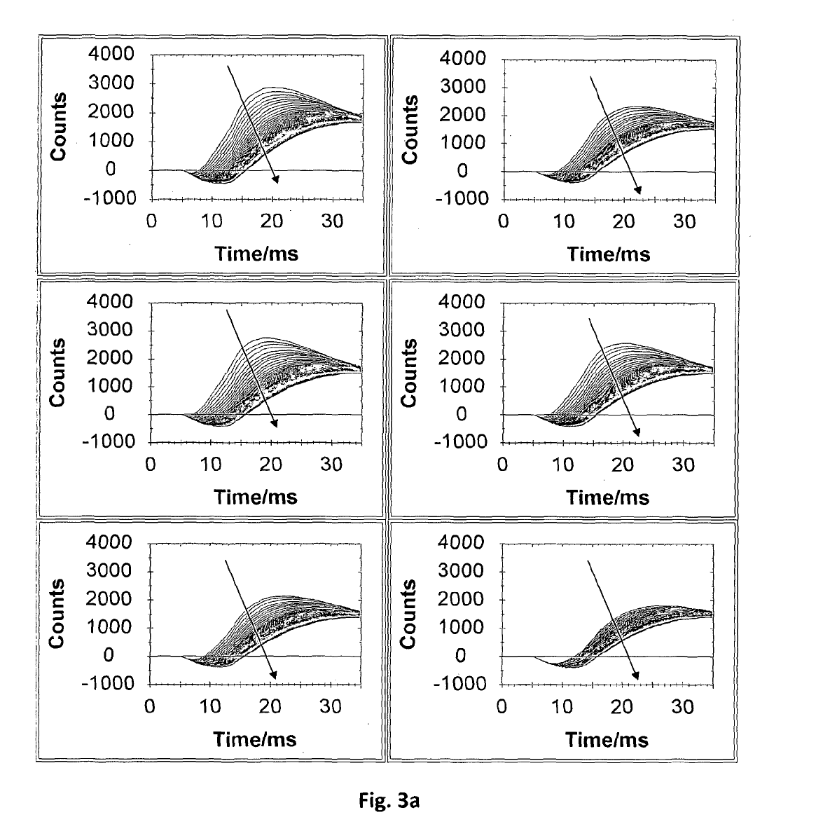

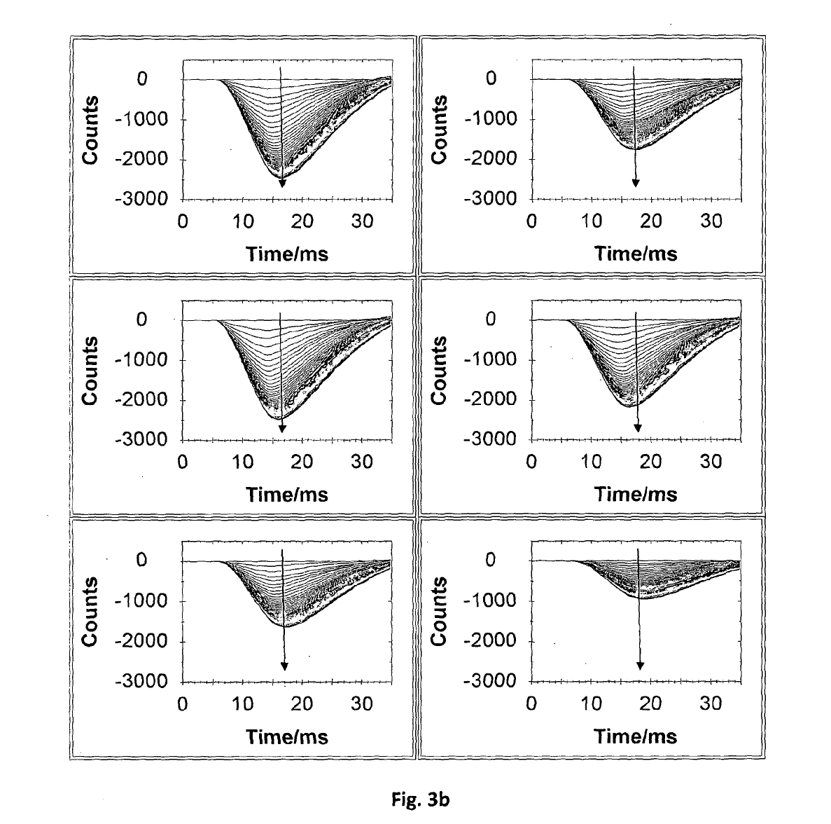

FIG. 2 shows a cartridge according to the present invention;

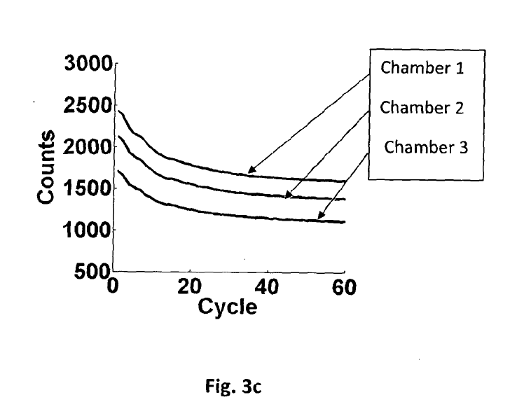

FIG. 3 shows a coagulation experiment with heparin where the blood does not clot (top is raw data/middle is baselined to cycle 1/bottom is a typical peak maximum with respect to cycle number), cycle number refers to data collected over a 30 second period, then averaged, the arrows depict the change in signal over the time of the experiment;

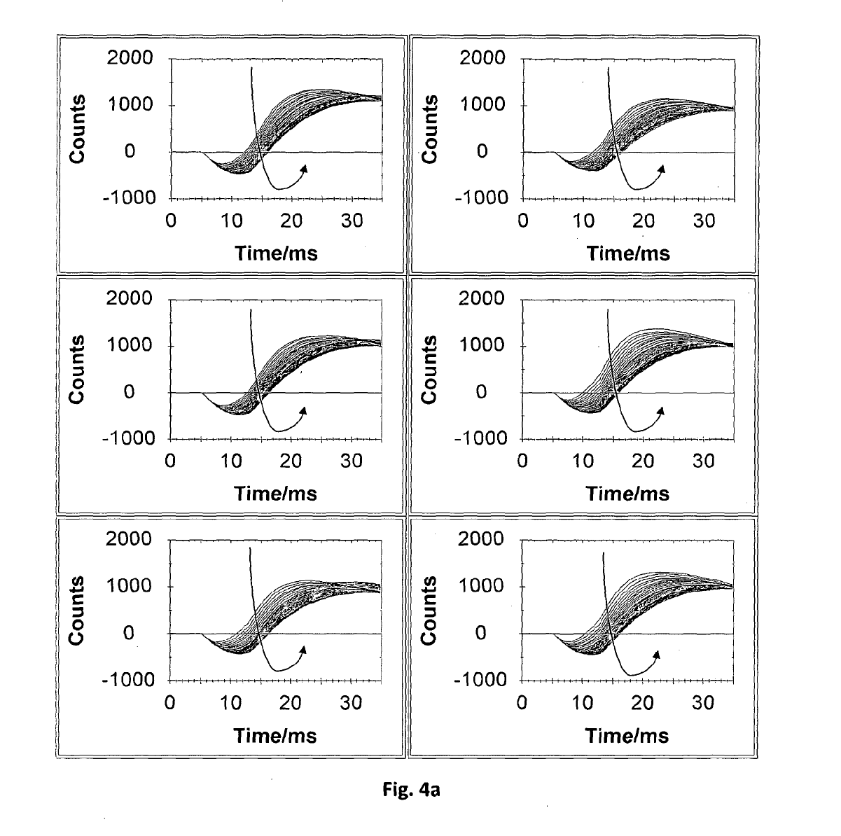

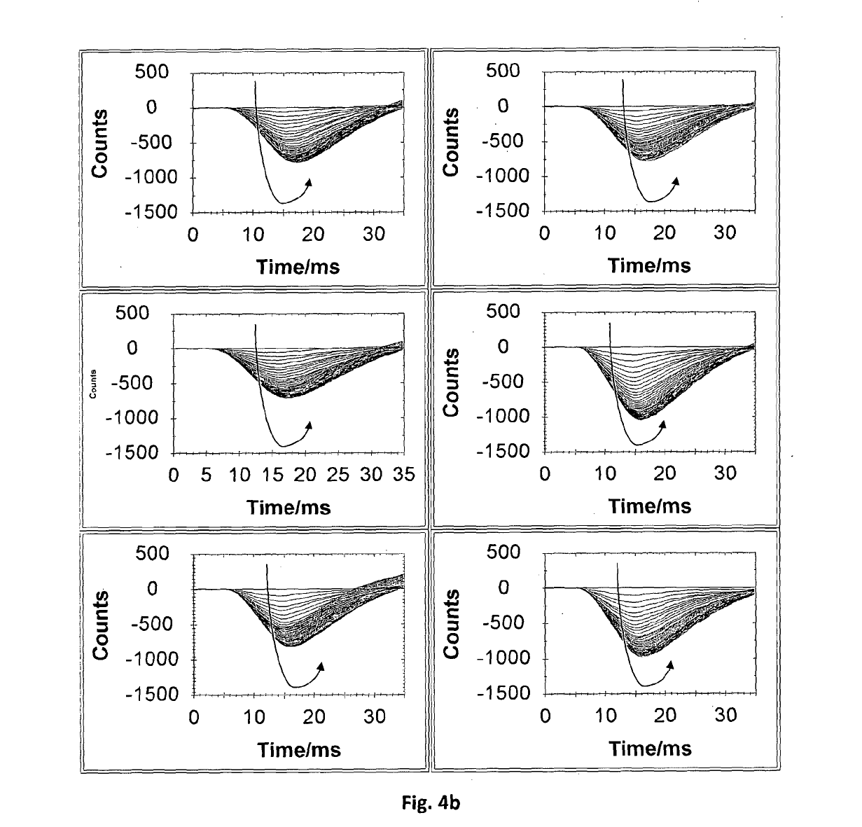

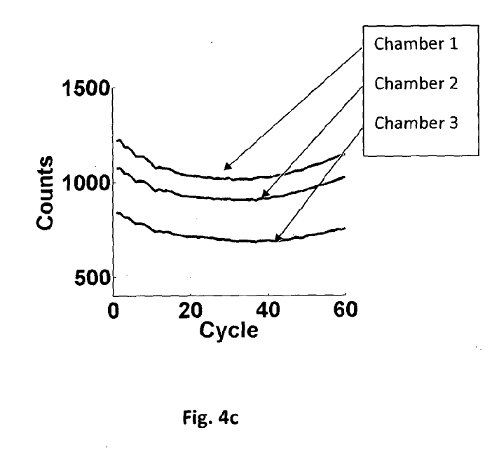

FIG. 4 shows a coagulation experiment without heparin where the blood does clot (top is raw data/middle is baselined to cycle 1/bottom is a typical peak maximum with respect to cycle number), the arrows depict the change in signal over the time of the experiment;

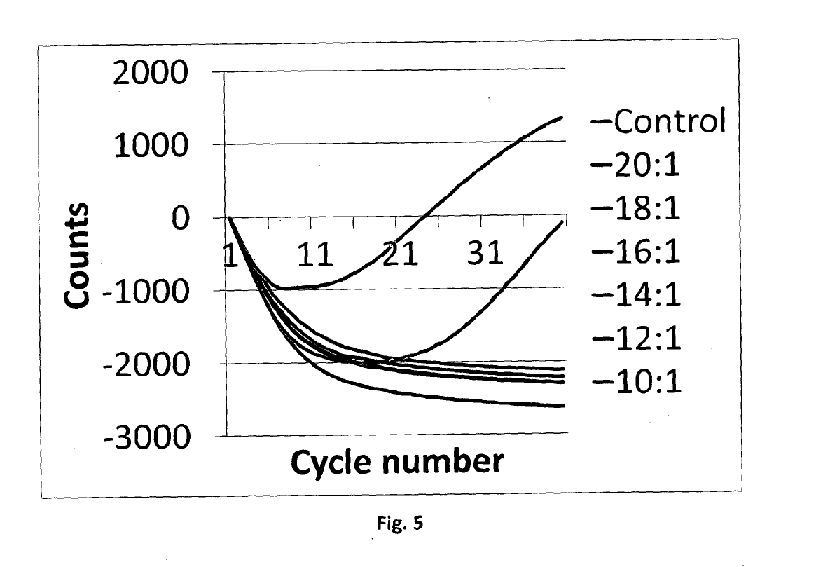

FIG. 5 shows average peak heights with respect to cycle number for varying thromboplastin ratios; and

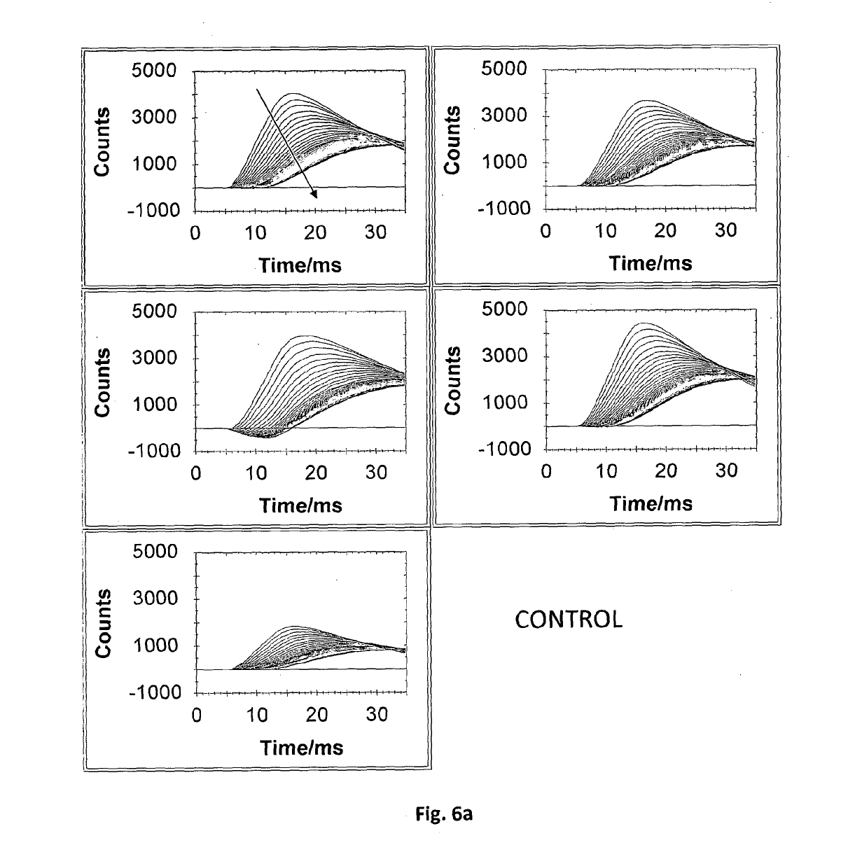

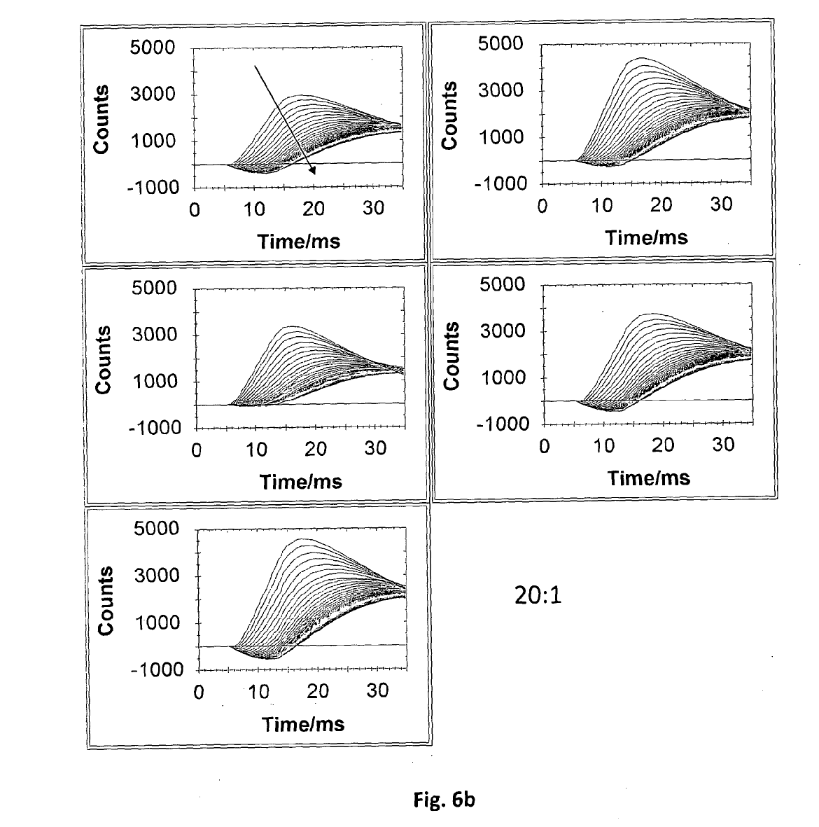

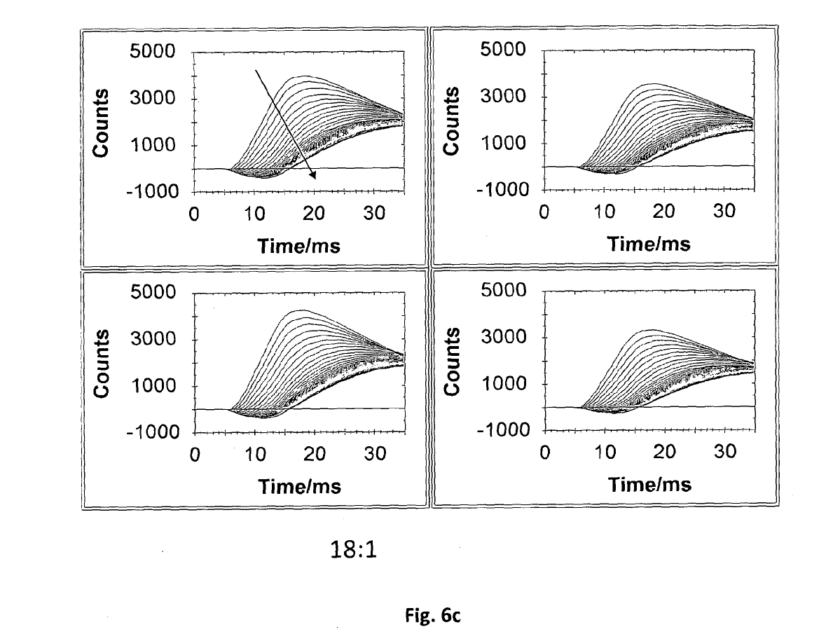

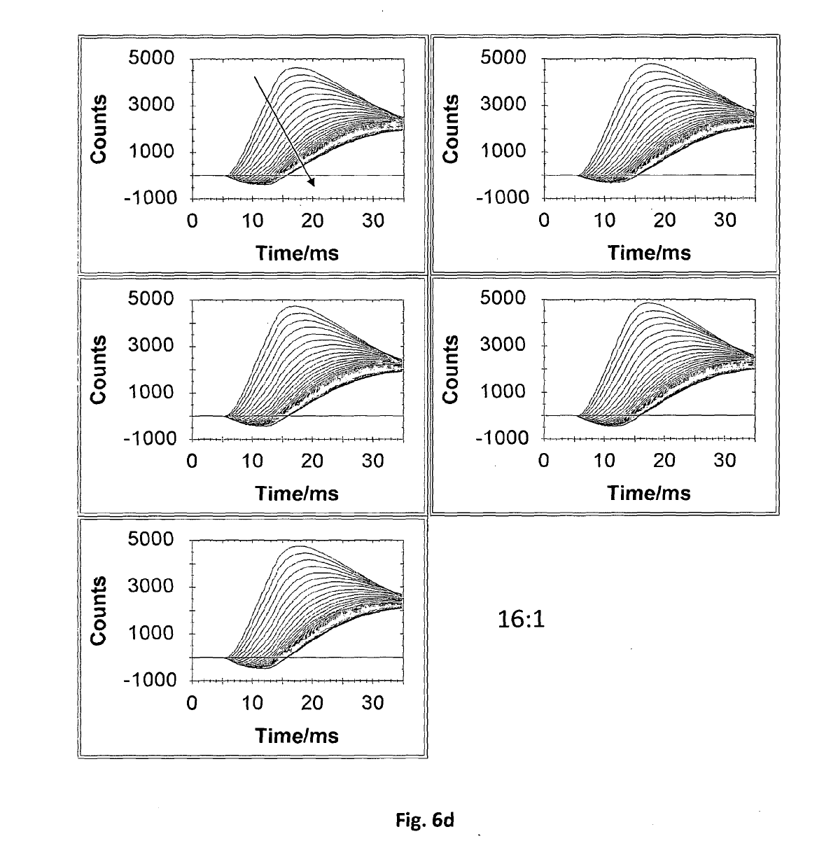

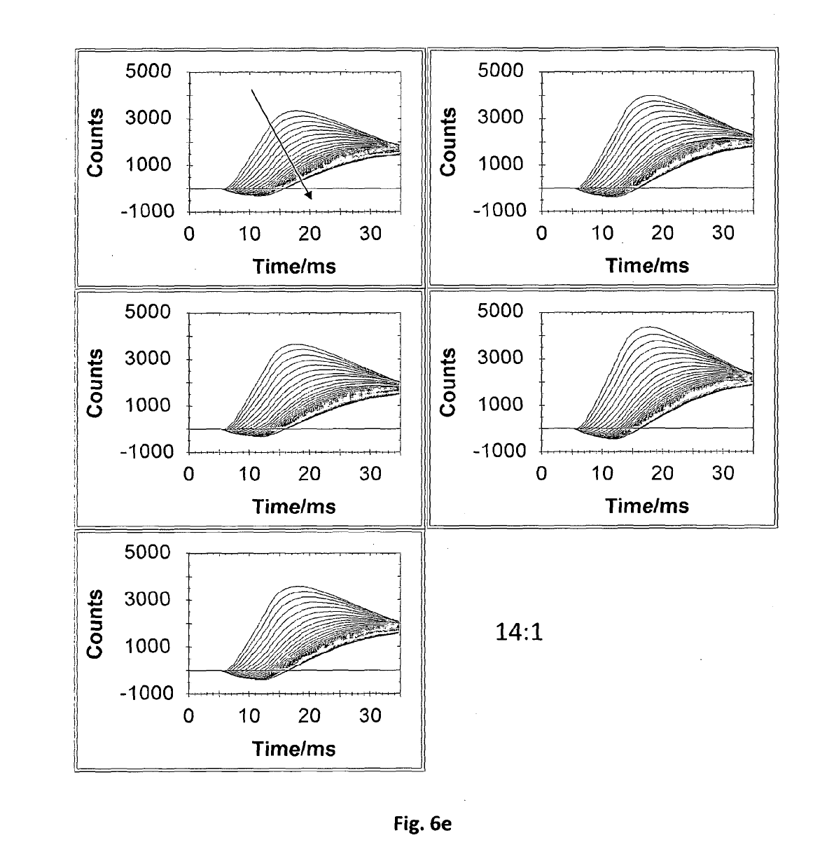

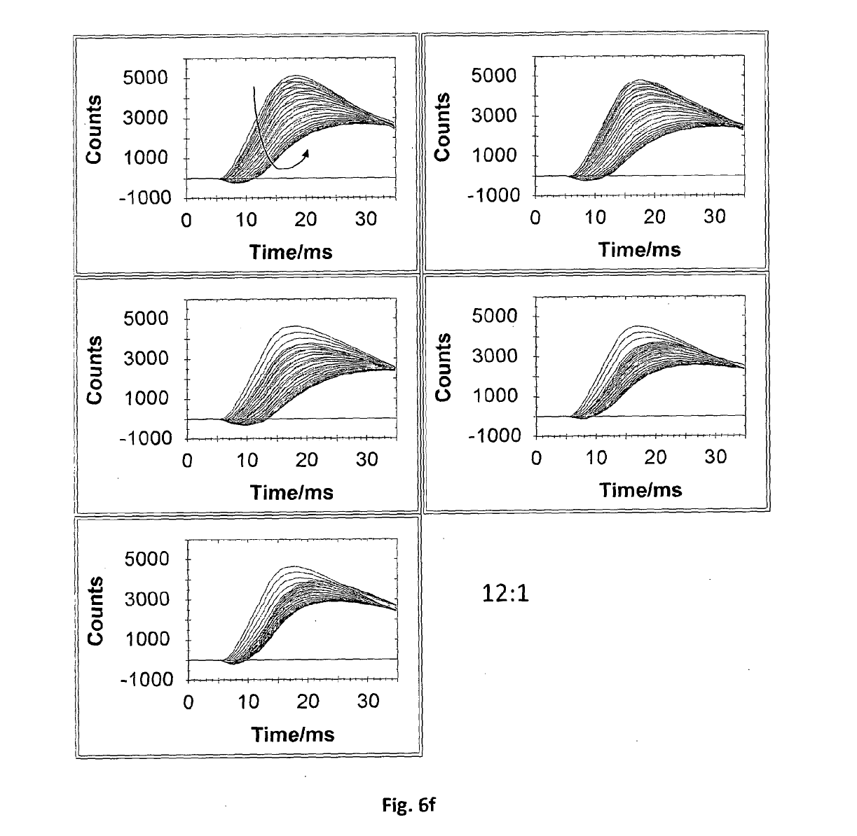

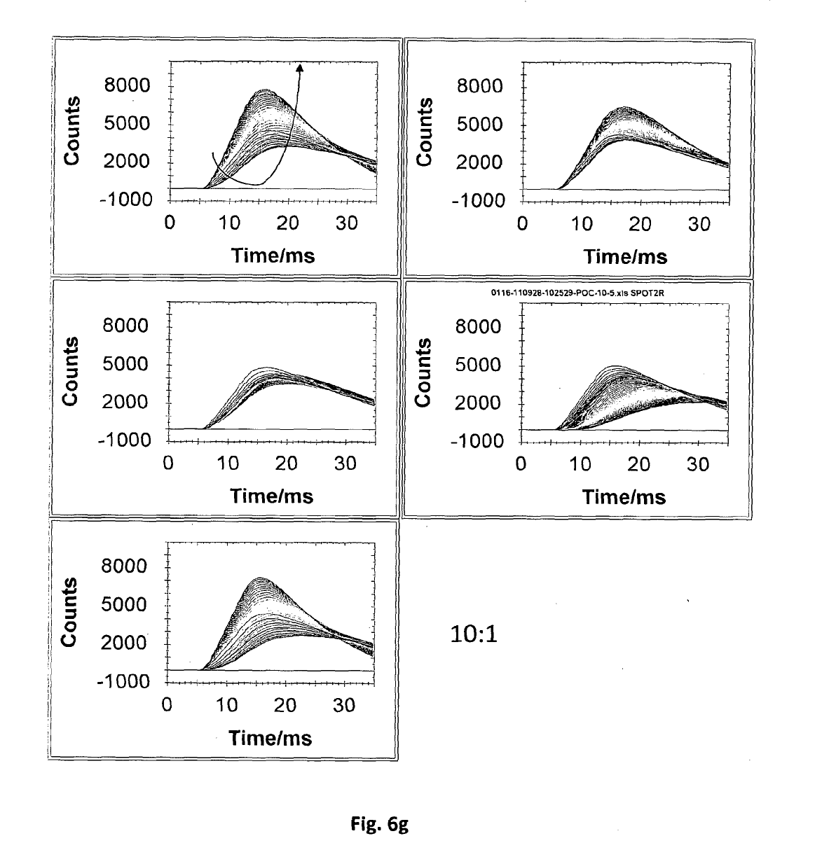

FIG. 6 shows raw traces for each of the ratios of thromboplastin, the arrows depict the change in signal over the time of the experiment.

The present invention employs a device comprising: a radiation source adapted to generate a series of pulses of electromagnetic radiation; a transducer having a pyroelectric or piezoelectric element and electrodes which is capable of transducing energy generated by non-radiative decay into an electrical signal; and a detector which is capable of detecting the electrical signal generated by the transducer. The device of the present invention is essentially based on the device described in WO 2004/090512.

FIG. 1 shows a device 1 for use in accordance with the present invention which relies on heat generation in a particle 2 on irradiation of the particle 2 with electromagnetic radiation (the particle is shown above the transducer surface). For the sake of simplicity, only the particle is shown in FIG. 1 (the remaining components of the device will be described in further detail hereinbelow). FIG. 1 shows the device 1 in the presence of a particle 2. The device 1 comprises a pyroelectric or piezoelectric transducer 3 having electrode coatings 4,5. The transducer 3 is preferably a poled polyvinylidene fluoride film. The electrode coatings 4,5 are preferably transparent and most preferably formed from indium tin oxide. The electrodes preferably have a thickness of about 35 nm, although almost any thickness is possible from a lower limit of 1 nm below which the electrical conductivity is too low and an upper limit of 100 nm above which the optical transmission is too low (it should not be less than 80% T). In a particularly preferred embodiment, the transducer is an indium tin oxide-coated polyvinylidene fluoride film. An additional layer may be applied to the transducer 3 to prevent cells or particles binding to that surface, such as a parylene polymer layer or an inert protein layer, e.g. a polystreptavidin layer.

The particle 2 is shown proximal to the transducer 3. A key feature of the present invention is that the particle 2 generates heat when irradiated by a source of electromagnetic radiation (typically termed “light”) 6, preferably visible light. The light source may be, for example, an LED. The light source 6 illuminates the particle 2 with light of the appropriate wavelength. Although not wishing to be bound by theory, it is believed that the particle 2 absorbs the light to generate an excited state which then undergoes non-radiative decay thereby generating energy, indicated by the curved lines in FIG. 1. This energy is primarily in the form of heat (i.e. thermal motion in the environment) although other forms of energy, principally a shock wave, may also be generated. The energy is, however, detected by the transducer and converted into an electrical signal. The device is calibrated for the particular particle being measured and hence the precise form of the energy generated by the non-radiative decay does not need to be determined. Unless otherwise specified the term “heat” is used herein to mean the energy generated by non-radiative decay. The light source 6 is positioned so as to illuminate the particle 2. Preferably, the light source 6 is positioned opposite the transducer 3 and electrodes 4,5 and the particle 2 is illuminated through the transducer 3 and electrodes 4,5. The light source may be an internal light source within the transducer in which the light source is a guided wave system. The wave guide may be the transducer itself or the wave guide may be an additional layer attached to the transducer. The wavelength of illumination depends on the particle used.

The energy generated by the particle 2 is detected by the transducer 3 and converted into an electrical signal. The electrical signal is detected by a detector 7. The light source 6 and the detector 7 are both under the control of the controller 8. The light source 6 generates a series of pulses of light which is termed “chopped light”. In principle, a single flash of light, i.e. one pulse of electromagnetic radiation, would suffice to generate a signal from the transducer 3. However, in order to obtain a reproducible signal, a plurality of flashes of light are used which in practice requires chopped light. The frequency at which the pulses of electromagnetic radiation are applied may be varied. At the lower limit, the time delay between the pulses must be sufficient for the time delay between each pulse and the generation of an electrical signal to be determined. At the upper limit, the time delay between each pulse must not be so large that the period taken to record the data becomes unreasonably extended. Preferably, the frequency of the pulses is from 1-50 Hz, more preferably 1-10 Hz and most preferably 2 Hz. This corresponds to a time delay between pulses of 20-1,000 ms, 100-1,000 ms and 500 ms, respectively. In addition, the so-called “mark-space” ratio, i.e. the ratio of on signal to off signal is preferably one although other ratios may be used without deleterious effect. There are some benefits to using a shorter on pulse with a longer off signal, in order to allow the system to approach thermal equilibrium before the next pulse perturbs the system. Sources of electromagnetic radiation which produce chopped light with different frequencies of chopping or different mark-space ratios are known in the art. The detector 7 determines the time delay between each pulse of light from light source 6 and the corresponding electrical signal detected by detector 7 from transducer 3. This time delay is a function of the distance, d. When particles are bound directly to the surface, the signal is preferably measured from 2-7 ms. For measuring particles through the depth of the chamber, longer time delays are used, e.g. 10-50 ms. The system can also be configured to measure the peak maximum in the signal, the time delay of which can change throughout the measurement process.

Any method for determining the time delay between each pulse of light and the corresponding electrical signal which provides reproducible results may be used. Preferably, the time delay is measured from the start of each pulse of light to the point at which a maximum in the electrical signal corresponding to the absorption of heat from particle is detected as by detector 7.

It should be noted that the particle 2 may be separated from the transducer surface and that a signal may still be detected. Moreover, not only is the signal detectable through an intervening medium, but that different distances, d, may be distinguished (this has been termed “depth profiling”) and that the intensity of the signal received is proportional to the concentration of the particle 2 at the particular distance, d, from the surface of the transducer 3. Moreover, it was found that the nature of the medium itself influences the time delay and the magnitude of the signal at a given time delay.

In the present invention, the particle may be a red blood cell (erythrocyte) or another particle. The purpose of the particle is to absorb the electromagnetic radiation generated by the radiation source to generate energy by non-radiative decay. The radiative decay is then converted to an electrical signal by the transducer. The wavelength of the electromagnetic radiation is such that the absorption of the radiation by the particles generates energy by non-radiative decay. For example, where red blood cells are being used to monitor the coagulation behaviour, the wavelength of the radiation is preferably 520 nm.

Red blood cells are present in a sample of blood, i.e. (unseparated) whole blood. These cells tend to sediment over time in a static system such as a test tube or container, since they are denser than the surrounding plasma in which they are dispersed. The system described in WO 2004/090512 is normally set up to minimise the signal from the red blood cells, by using a wavelength of light at which the signal from red blood cells is minimised (around 690 nm), and also by measuring the signal a few milliseconds after the light pulse, thus confining the output to heat generated in close proximity to the transducer. However, by measuring the electrical signal at the appropriate wavelength, and at a later time period after the pulse, it is possible to gain more information about particles further away from the surface. It is thus possible to use the above-described system to monitor the movement of the particles over time, e.g. the sedimentation of the red blood cells.

It has been found that the signal obtained from the sedimenting red blood cells drops initially as the cells sediment, but then starts to rise again as coagulation takes place. This unexpected finding is not fully understood. However, although not wishing to be bound by theory, this could be the result of two phenomena. The first is that the red cells start to fall away initially, but are then forced upwards again as the clot forms. This may be related to a process known as clot retraction. The second is that the heat transfer process is different in the clotted sample, so that more heat is transferred through the clotted sample to the transducer. However, the advantage of measuring this process is that it provides a signal which has a distinct minimum (it could also be a maximum if the particles are initially moving towards the transducer, e.g. if the transducer formed the bottom of the chamber), which is more characteristic of the clotting process. This characteristic signal allows for a more effective analysis of the electrical signal generated by the transducer. This in turn provides a clinically useful measure of the rate of coagulation in the sample.

The coagulation process may also be measured in any blood product which is able to undergo coagulation. Such blood products contain fibrinogen and clotting factors. Preferably the blood product is (unseparated) whole blood or blood plasma.

The particles used to carry out the measurement must be capable of absorbing the electromagnetic radiation generated by the radiation source to generate energy by non-radiative decay at the wavelength of the electromagnetic radiation used. The particles will be more or less dense than the medium of the sample (principally water, but blood products also contain dissolved proteins, glucose, clotting factors, mineral ions, hormones and dissolved gases, principally carbon dioxide). Typically the particles will be more dense than the medium and hence will sediment under gravity. However, the particles could also be less dense than the medium and the movement of the particle would be upwards, controlled by the buoyancy of the particle in the medium. Either way, the movement of the particles towards or away from the transducer changes as the movement is affected by the formation of the clot.

The sedimentation rate (or buoyancy) of the particles is a function of both the size of the particle and its density. Sedimentation (or buoyancy) must occur at such a rate that it is measurable on the time scale of the coagulation process, which is typically seconds to minutes. Thus, very large, dense particles may sediment to the bottom of the chamber before the coagulation process has taken place, whereas very small particles of density similar to plasma may not sediment fast enough for the process to be measurable. Accordingly, a balance between size and density must be provided which is suitable for the given assay.

Preferably, the present invention uses a particle having a particle size of 20 nm to 10 μm. By particle size is meant the diameter of the particle at its widest point. The particle preferably has a density of 0.8 to 20 g/mL. By way of example, red cells have a diameter of around 7 microns and a density of approximately 1.1 g/mL.

Where the particle is a red blood cell, the measurement occurs by sedimentation of the red blood cells. For other particles, the particles will typically be denser than the surrounding medium and hence the measurement occurs by sedimentation, but they could also be less dense. The particles will move away from the transducer or towards the transducer depending on the nature of the particles (more or less dense than the medium) and the location of the transducer (above or below the sample).

In the case of unseparated whole blood, the red blood cells can act as the particle as defined herein. However, other particles can be added to provide an additional or alternative source of absorption/non-radiative decay. In the case of plasma, or other blood products where the red blood cells have been removed, a particle must be added in order for the sedimentation (or buoyancy) to be measured.

The particles may therefore be composed of any material which is capable of interacting with the electromagnetic radiation in the described manner. Preferably the particles are selected from, but not limited to, carbon particles (e.g. density 2 g/mL and size 200 nm), coloured-polymer particles (preferably coloured latex, e.g. 20 to 2,000 nm), dye particles, metal (preferably gold) particles (of density around 15-20 g/mL and size around 20 to 100 nm), blood cells, magnetic particles, nanoparticles having a non-conducting core material and at least one metal shell layer, particles composed of polypyrrole or a derivative thereof, and combinations thereof.

In the case of a magnetic particle, the electromagnetic radiation is radio frequency radiation. All of the other particles mentioned hereinabove employ light, which can include IR or UV radiation. Gold particles are commercially available or may be prepared using known methods (see for example G. Frens, Nature, 241, 20-22 (1973)). For a more detailed explanation of the nanoparticles see U.S. Pat. No. 6,344,272 and WO 2007/141581.

Preferably the particles are red blood cells, carbon particles or gold particles, and in a particularly preferred embodiment, the sample is whole blood and the only particles present which are capable of absorbing the electromagnetic radiation generated by the radiation source to generate energy by non-radiative decay are red blood cells.

The sample will typically be in the order of microlitres (e.g. 1-100 μL, preferably 1-30 μL). In order to hold a fluid sample, the transducer is preferably located in a chamber, the chamber having one or more side walls, an upper surface and a lower surface. Accordingly, the transducer is preferably located within a chamber for holding the sample in contact with the transducer. Preferably, the transducer is integral with the chamber, i.e. it forms one of the side walls, or upper or lower surface which define the chamber. In a preferred embodiment, the chamber has an upper surface and a lower surface and the transducer forms the upper surface. The sample may simply be retained by surface tension forces, for example, inside a capillary channel. The depth of the chamber is typically 50 μm to 1 cm, preferably 150-250 μm.

In order to facilitate the handling of the sample and the measurement itself, the sample preferably contains an anticoagulant and/or a procoagulant.

One or more anticoagulants may be added to the sample to delay the onset of coagulation. The anticoagulant may be added at any stage after the sample has been taken. A typical anticoagulant is heparin, citrate or EDTA.

Although whole blood contains all of the necessary factors to cause clotting by the intrinsic pathway, one or more procoagulants may also be added to the sample. The procoagulants may be selected to activate the intrinsic, extrinsic or common pathways of the coagulation cascade.

Activation via the intrinsic pathway may be accomplished by adding a contact activator, such as ellagic acid, collagen or silica. The silica may be kaolin, micronised silica or colloidal silica. The contact activator may be applied to interior surface of the chamber using a coating, such as polyvinylpyrrolidone (PVP). Alternatively, Factor XIIa, Factor XIa or Factor IXa may be used, as well as prothrombin, Factor VIII/Factor VIIIa and Factor X.

Activation via the extrinsic pathway may be accomplished by adding a tissue factor, with or without the addition of Factor VII/Factor VIIa. Alternatively, activation may be accomplished by Factor VIIa, optionally with prothrombin, Factor V/Va, Factor IX or Factor X.

Activation via the common pathway may be accomplished by addition of exogenous Factor Xa, or by addition of exogenous Factor X in combination with an exogenous activator of Factor X, such as a snake venom enzyme (e.g. snake venom enzyme from Russelli Viperii). Alternatively, the exogenous activator of Factor X may be added for activation of endogenous Factor X. Optionally, prothrombin and/or Factor V/Va may be added.

As well as the above-described procoagulants, surfactants may be added, such as phospholipids or a silicone surfactant.

The anticoagulant and/or procoagulant are preferably stored in a chamber incorporated into the device of the present invention. The anticoagulant and/or procoagulant may be deposited onto the surface of the transducer.

The present invention also provides a device for measuring coagulation in a sample of a blood product containing particles which are capable of absorbing electromagnetic radiation to generate energy by non-radiative decay, the device comprising:
a radiation source adapted to generate a series of pulses of electromagnetic radiation at a wavelength such that the absorption of the radiation by the particles generates energy by non-radiative decay;
a sample chamber containing a transducer having a pyroelectric or piezoelectric element and electrodes which is capable of transducing energy generated by non-radiative decay into an electrical signal; and
a detector which is capable of detecting the electrical signal generated by the transducer; wherein the device further comprises a procoagulant and, optionally, an anticoagulant.

The device of the present invention may contain a plurality of chambers, preferably in fluid communication. The device preferably further contains an elongate sample collection passage having a sample collection end which is contact with the outside of the device and a sample delivery end which is in fluid communication with the sample chamber(s), as shown in the core 21 in FIG. 2. See WO 2011/027147 for further details. Different coagulation measurements may be performed in the different chambers; indeed, the other chambers may contain other assay components, e.g. for an immunoassay.

In a preferred embodiment, the device further comprises an elongate sample collection passage having open ends and arranged to draw the fluid into the passage by capillary action, wherein the passage has a collection end and a delivery end and the delivery end is in fluid communication with the sample chamber, and wherein the passage is provided along a first portion of its length with a region coated with an anticoagulant and along a second portion of its length with a region coated with a procoagulant, such that the sample contacts the first portion prior to the second portion. This arrangement allows the sample to contact the anticoagulant to prevent clotting in the collection passage, followed by contact with the procoagulant to facilitate the measurement.

The device may take the form of a separate reader and cartridge, or an integrated device. In the former, the device is formed of a reader and a cartridge, in which the cartridge is releasably engageable with the reader, and in which the reader incorporates the radiation source and the detector, and the cartridge incorporates the transducer and the chamber. The reader is preferably a portable reader. The cartridge is preferably a disposable cartridge.

The present invention will now be described with reference to the following examples which are not intended to be limiting.

### EXAMPLES

### Example 1

### PVDF Film

A poled piezo/pyroelectric polyvinylidene fluoride (PVDF) bimorph film, coated in indium tin oxide was used as the sensing device in the following examples. The indium tin oxide surface was coated with a layer of parylene (of approximate thickness 1 micron) by a vapour phase gas deposition process. This method involved the sublimation and subsequent pyrolysis of a paracyclophane precursor, followed by a free-radical polymerisation on the surface. See WO 2009/141637 for further details. The resulting film was then coated in polystreptavidin solution (200 μg/mL in PBS—10 mmol/L phosphate buffer containing 2.7 mmol/L KCl, 137 mmol/L NaCl and 0.05% Tween) by incubation at room temperature overnight. Polystreptavidin was prepared as described by Tischer et al (U.S. Pat. No. 5,061,640). The polystreptavidin is simply an inert protein layer to cover the surface of the sensor.

### Example 2

### Preparation of the Cartridge

As shown in FIG. 2, a cartridge 14 was fabricated to perform the measurement. The cartridge 14 was fabricated from a piezo/pyrofilm 15 supported on a stiffener 16. A pressure sensitive adhesive-coated polyester film 17 die-cut to form three sample chambers 18 was applied to the surface. Provision was made to allow for electrical connections to the top and bottom surfaces of the piezo/pyrofilm 15 in order to detect the charge generated. The cartridge 14 was then formed by sandwiching the above components between a top cover 19, to which a label 20 was applied, and a core 21, seal 22 and bottom cover 23.

Measurements were carried out by charging the sample chambers with the sample. The piezo/pyrofilm 15 was irradiated through the holes in the top cover 19 with chopped LED light sequentially with LEDs. For each LED pulse, a voltage is measured across the piezo/pyrofilm 15 using an amplifier and analogue to digital (ADC) converter. The time-resolved ADC signal is plotted over time.

### Example 3

### Coagulation 1: With and Without Heparin

A venous blood sample was drawn in to a heparin collection tube. Additionally, about 500 μL of blood from a finger stick was collected into an eppendorf tube (without anticoagulant) from the same donor. Both samples were oxygenated by mixing on a vortexer for about 30 s. After vortexing, both samples were loaded into the sensor wells of the cartridge by pipetting, and inserted into an instrument for carrying out the measurement. In this example the sample collection tube in the cartridge was by-passed.

The data for samples are shown in FIGS. 3 and 4, respectively.

FIG. 3 shows a normal change in signal, i.e. the signal drops away over time as the blood sample sediments away from the sensor surface. The peak maximum versus cycle number also shows this relationship and highlights the relatively sharp drop away which gradually tails off towards the end of the run. In contrast, FIG. 4 shows a significantly different profile for the sample without anticoagulant. The sample does not drop away as much, but more importantly, reaches a minimum value approximately half way through the run after which the signal then starts to increase again. All of the cartridges exhibited this behaviour. (This is a surprising finding as one would expect that once the sample has coagulated, the blood cells should stop moving and therefore would have a constant signal/peak height.)

These data have shown there is a distinguishable difference between the sedimentation profiles of uncoagulated and coagulated blood samples.

### Example 4

### Coagulation 2: Thromboplastin Reagent

Unlike in Example 3, coagulation was controlled by adding a specific coagulating agent to the sample.

Commercial prothrombin time clotting agent (TEClotPT-S) was used. This commercially available reagent principally contains thromboplastin and calcium. In a standard prothrombin time test, the sample is collected in a citrate collection tube. The reagent is then added to this in a 2:1 ratio of PT reagent:sample. Typically the blood or plasma clots in the order of 10 to 20 s. Therefore to slow the reaction down (in order to facilitate measurement), the reagent was titrated to determine a level which would cause coagulation in a time scale that would be suitable to observe with the instrument. (It should be noted that, as an alternative, the instrument could be configured to measure timescales of 10 to 20 s.) The longer time was used because this instrument configuration was available for the experiment.

A venous blood sample was collected from donor in a citrate tube. This was then mixed with varying ratios of PT ranging from 10:1 to 20:1 blood to reagent. This corresponds to PT volumes ranging from 5% to 10% by volume. After mixing, the samples were immediately loaded into the cartridges and inserted into an instrument for carrying out the measurements.

The peak height was plotted versus cycle number and these data are shown in FIG. 5 below for each of the ratios.

For ratios of 20:1 to 14:1, the samples show normal drop away indicating they are not significantly coagulated. Both 12:1 and 10:1 show the typical profile observed in FIG. 4 for coagulated material; that is, the peak height drops to a minimum before increasing indicating coagulation. This also shows that at the most concentrated level, the signal reaches the minimum more quickly showing that differences in coagulation can be discriminated by monitoring the shape of the signal and the time until the signal starts to rise.

For completeness, the raw data are shown for each of the samples in FIG. 6 below.

For clinical measurements, the system is calibrated to normal human blood samples (and existing coagulation methods) to identify the time taken for a sample to coagulate normally under the conditions of a specific type of coagulation test. The calibrated system is then used to measure the time of coagulation of patient blood samples. Changes in the time to coagulation are used to identify if the blood sample coagulates more or less rapidly than a normal sample. This may then be used to make a clinical diagnosis, or to adjust existing therapy to bring the coagulation time back into the normal range.

1. A method for measuring coagulation in a sample of a blood product comprising:
providing a transducer having a pyroelectric or piezoelectric element and electrodes which is capable of transducing energy generated by non-radiative decay into an electrical signal;
contacting the transducer with the sample;
irradiating the sample with a series of pulses of electromagnetic radiation;
and detecting the electrical signal generated by the transducer;
wherein the sample contains particles which are capable of absorbing the electromagnetic radiation generated by the radiation source to generate energy by non-radiative decay and wherein the wavelength of the electromagnetic radiation is such that the absorption of the radiation by particles generates energy by non-radiative decay.

2. A method as claimed in claim 1, wherein the blood product is whole blood or blood plasma.

3. A method as claimed in claim 1, wherein the particles are selected from carbon particles, coloured-polymer particles, dye particles, metal particles, red blood cells, magnetic particles, nanoparticles having a non-conducting core material and at least one metal shell layer, particles composed of polypyrrole or a derivative thereof, and combinations thereof.

4. A method as claimed in claim 3, wherein the particles are red blood cells or carbon particles.

5. A method as claimed in claim 4, wherein the sample is whole blood and the only particles present which are capable of absorbing the electromagnetic radiation generated by the radiation source to generate energy by non-radiative decay are red blood cells.

6. A method as claimed in claim 1, wherein the transducer is located within a chamber for holding the sample in contact with the transducer.

7. A method as claimed in claim 6, wherein the chamber has an upper surface and a lower surface and the transducer forms the upper surface.

8. A method as claimed in claim 1, wherein sample contains an anticoagulant and/or a procoagulant.

9. A device for measuring coagulation in a sample of a blood product containing particles which are capable of absorbing electromagnetic radiation to generate energy by non-radiative decay, the device comprising:
a radiation source adapted to generate a series of pulses of electromagnetic radiation at a wavelength such that the absorption of the radiation by the particles generates energy by non-radiative decay;
a sample chamber containing a transducer having a pyroelectric or piezoelectric element and electrodes which is capable of transducing energy generated by non-radiative decay into an electrical signal; and
a detector which is capable of detecting the electrical signal generated by the transducer;
wherein the device further comprises a procoagulant and, optionally, an anticoagulant.

10. A device as claimed in claim 9, wherein the chamber has an upper surface and a lower surface and the transducer forms the upper surface.

11. A device as claimed in claim 9, wherein the device is formed of a reader and a cartridge, in which the cartridge is releasably engageable with the reader, and in which the reader incorporates the radiation source and the detector, and the cartridge incorporates the transducer and the chamber.

12. A device as claimed in claim 9, wherein the device further comprises an elongate sample collection passage having open ends and arranged to draw the fluid into the passage by capillary action, wherein the passage has a collection end and a delivery end and the delivery end is in fluid communication with the sample chamber, and wherein the passage is provided along a first portion of its length with a region coated with an anticoagulant and along a second portion of its length with a region coated with a procoagulant, such that the sample contacts the first portion prior to the second portion.
